(19) United States
(12) Patent Application Publication
(10) Pub. No.: US 2023/0101875 A1
(43) Pub. Date: Mar. 30, 2023

(54) BALLISTIC COMPOSITION, BALLISTIC ASSEMBLY, AND METHOD THEREFOR

(71) Applicant: Zephyros, Inc., Romeo, MI (US)

(72) Inventors: Blake SYNNESTVEDT, Romeo, MI (US); Jason WALKER, Romeo, MI (US); Hamid MORTAZAVIAN, Romeo, MI (US)

(21) Appl. No.: 17/801,420

(22) PCT Filed: Feb. 24, 2021
(86) PCT No.: PCT/US2021/019464

§ 371 Date: Aug. 22, 2022

Related U.S. Application Data
(60) Provisional application No. 62/980,594, filed on Feb. 24, 2020.

(51) Int. Cl. F41H 5/04; B32B 13/02; B32B 27/18

(52) U.S. Cl. CPC F41H 5/0492; F41H 5/0471; B32B 13/02; B32B 27/18; B32B 27/38

(57) ABSTRACT

A ballistic composition, ballistic assembly, and method for fabricating the ballistic assembly. The ballistic composition comprises a curable material, and a particulate component. The particulate component is adapted to impose a tortuous path on a projectile. The particulate component includes polymer, ceramic, metal, or any combination thereof.

### FIELD

The present teachings generally relate to a ballistic composition, ballistic assembly incorporating the same, and method for fabricating the ballistic assembly. The ballistic composition, ballistic assembly, and method may be particularly advantageous in providing ballistic protection.

### BACKGROUND

Ballistic protection is typically implemented on the body, vehicles, or structures (e.g., government buildings) for applications such as government, military, private protection services, or personal defense.

Typically, ballistic protection is installed on vehicles by aftermarket shops. In doing so, the installation incurs costs involved with tearing down portions of the vehicle before installing the ballistic protection. Original Equipment Manufacturers (OEM's) have not been able to and/or incentivized to install ballistic protection on consumer vehicle assembly lines because not every consumer would want the add-on option of ballistic protection and as of yet, there has not been a cost-efficient and/or process-efficient solution for adding ballistic protection to vehicles on an individual basis. In addition, OEM installation would require either materials compatible with the electrocoating (E-coat) process and/or materials that can be added to the vehicle with ease after the E-coat process.

Installing ballistic protection on vehicles presents several challenges such as added weight, space limitations in the existing vehicle structure, forming the ballistic protection to fit unique shapes of vehicle components, and fitting ballistic protection to a vast number of different vehicle constructions (i.e., makes, models, model years, and vehicle trim packages). Added weight decreases gas mileage and slows down vehicles. Pressures in the automotive industry to reduce the size and weight of vehicles while increasing the number of functional components (e.g., side-airbags, HVAC, electronics, and the like) leaves little extra room for the inclusion of ballistic protection. Some vehicle components have complex shapes and/or limited free space (e.g., liftgates, A-pillars, and B-pillars) and fitting ballistic protection to those shapes involves complicated processes of forming, cutting, and the like. The vast number of vehicle constructions on the market and in-use today necessitates customized ballistic protection articles for each variant of vehicle and can add to the cost and cycle time of installing the ballistic protection.

There is thus a need for ballistic protection that can be installed, at least in part, by OEM's so the costs of aftermarket services may be avoided. There is a need for ballistic protection that achieves one or more of the following: low cost to produce and/or install, shorter installation time, lightweight, able to be fit to vehicle components having complex shapes and/or little free space, and able to be efficiently adapted to a vast number of vehicle constructions.

### SUMMARY

The present teachings provide a ballistic composition, ballistic assembly, and method for fabricating the ballistic assembly, which addresses at least some of the needs identified above.

The ballistic composition may comprise: a curable material, and a particulate component adapted to impose a tortuous path on a projectile. The particulate component may include polymer, ceramic, metal, or any combination thereof.

The curable material may include a polymeric material. The curable material may include a cement. The curable material may be present in the ballistic composition in an amount of about 5% to 80%, by weight of the ballistic composition. The ballistic composition may include a fiber component. The fiber component may be adapted to impose a tortuous path on a projectile. The fiber component may be present in the ballistic composition in an amount of about 1% to 60%, by weight of the ballistic composition. The fiber component may include polymeric fiber, glass fiber, carbon fiber, or any combination thereof. The ballistic composition may comprise a blowing agent. The blowing agent may be present in the ballistic composition in an amount of about 0.001% to 5%, by weight of the ballistic composition.

The ballistic composition may foam, upon exposure to a stimulus, to a volume of about 5% to 800%, relative to a green state volume of the ballistic composition. The curable material may activate at a temperature of between about 82° C. and 193° C. The curable material may activate at a temperature of between about 20° C. and 25° C. The ballistic composition may comprise a curing agent. The curing agent may be present in the ballistic composition in an amount of about 0.001% to 10%, by weight of the ballistic composition. The particulate component may be present in the ballistic composition in an amount of about 5% to 70%, by weight of the ballistic composition.

The fiber component, the particulate component, or both may be homogenously dispersed throughout the ballistic composition. In an activated state, the ballistic composition may meet UL 752, NIJ Standard-0101.06, NIJ Standard-0115.00, or any combination thereof.

The ballistic assembly may comprise: a ballistic composition and one or more ballistic inserts. The ballistic composition may include a curable material, and a particulate component.

The particulate component may be adapted to impose a tortuous path on a projectile. The particulate component may include polymer, ceramic, metal, or any combination thereof.

The curable material may include a polymeric material. The curable material may include a cement. The curable material may be present in the ballistic composition in an amount of about 5% to 80%, by weight of the ballistic composition. The ballistic composition may include a fiber component. The fiber component may be adapted to impose a tortuous path on a projectile. The fiber component may be present in the ballistic composition in an amount of about 1% to 60%, by weight of the ballistic composition. The fiber component may include polymeric fiber, glass fiber, carbon fiber, or any combination thereof. The ballistic composition may comprise a blowing agent. The blowing agent may be present in the ballistic composition in an amount of about 0.001% to 5%, by weight of the ballistic composition.

The ballistic composition may foam, upon exposure to a stimulus, to a volume of about 5% to 800%, relative to a green state volume of the ballistic composition. The curable material may activate at a temperature of between about 82° C. and 193° C. The curable material may activate at a temperature of between about 20° C. and 25° C. The ballistic composition may comprise a curing agent. The curing agent may be present in the ballistic composition in an amount of about 0.001% to 10%, by weight of the ballistic composition. The particulate component may be present in the ballistic composition in an amount of about 5% to 70%, by weight of the ballistic composition.

The fiber component, the particulate component, or both may be homogenously dispersed throughout the ballistic composition. In an activated state, the ballistic composition may meet UL 752, NIJ Standard-0101.06, NIJ Standard-0115.00, or any combination thereof.

The method for fabricating a ballistic assembly may comprise: applying a ballistic composition to a ballistic insert and curing the ballistic composition. The ballistic composition may comprise a curable material, a fiber component, a particulate component, or any combination thereof. The particulate component may include polymer, ceramic, metal, or any combination thereof. The particulate component may be adapted to impose a tortuous path on a projectile.

The ballistic composition may be partially cured prior to being applied to the ballistic insert. The ballistic composition may be pre-formed prior to being applied to the ballistic insert. The ballistic composition may be applied to the ballistic insert by pumping and/or flowing, overmolding, co-extruding, co-injection molding, mechanical fastening, chemical fastening, or any combination thereof.

The method may further include installing the ballistic insert onto a component of a vehicle. The ballistic insert may be disposed within a cavity of the vehicle. Prior to applying the ballistic composition to the ballistic insert, the ballistic insert may be installed onto a component of a vehicle.

The ballistic composition may activate at a temperature range of between about 82° C. and about 193° C. The ballistic composition may be activated in an E-coat oven. The ballistic composition may activate at a temperature of between about 20° C.-25° C.

### BRIEF DESCRIPTION OF THE DRAWINGS

FIG. 1 illustrates two ballistic inserts and a ballistic composition disposed therebetween.

### DESCRIPTION

The present teachings meet one or more of the above needs by the improved ballistic composition, ballistic assembly, and method described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Ballistic protection may be characterized as either hard armor (e.g., polymer plates, ceramic plates, or metal plates) or soft armor (e.g., Kevlar®). In some applications, hard armor and soft armor may be used together. For example, a panel of soft armor may be stacked with a panel of hard armor. The present disclosure provides for a unique and unconventional application in which the benefits of both hard armor and soft armor may be realized. The ballistic composition and/or ballistic insert may provide the benefits of soft armor, including low-cost, low-weight, ease of forming articles from the ballistic composition, or any combination thereof. The ballistic composition and/or ballistic insert may provide the benefits of hard armor, including resistance to penetration, resistance against high-velocity projectiles, or both. The ballistic composition of the present disclosure may include a curable material, particulate component, fiber component, or any combination thereof. The particulate component, fiber component, or both may impose a tortuous path on a projectile. The curable material, fiber component, or both may provide for properties of soft armor. The particulate component may provide for properties of hard armor. By dispersing the particulate component within the ballistic composition, the benefits of hard armor may be realized while generally avoiding the provision of hard armor as a unitary, generally planar, rigid panel, which are heavy and not easily formed to complement complex shapes. The curable material, particulate component, fiber component, or any combination thereof may cooperate to absorb and/or disperse the energy of a projectile. In this manner, a projectile may become embedded in the ballistic composition, ballistic insert, or both. The projectile may be prevented from passing completely through the ballistic assembly. The ballistic composition may be applied to a ballistic insert, forming a ballistic assembly. The ballistic composition may be applied to a vehicle without a ballistic insert. For example, a ballistic composition may be pumped into a cavity of an A-pillar.

The ballistic composition and/or ballistic insert of the present disclosure may be implemented on vehicles or architectural structures, although other applications are contemplated. The vehicles may include, but are not limited to, consumer vehicles (e.g., sedans or sport utility vehicles), fleet vehicles (e.g., police cruisers), military vehicles (e.g., Humvees), the like, or any combination thereof. The vehicle may include one or more components including body components, interior components, drivetrain components, electronics components, or any combination thereof. The components may define and/or be located within one or more compartments. The body components may include floors, doors, roofs, hoods, fenders, bumpers, trunks, hatches, liftgates, A-pillars, B-pillars, sills, roof bows, floor cross members, bulkheads, battery trays, the like, or any combination thereof. The battery trays may include battery trays for combustion engine vehicles, electric vehicles, or both. The interior components may include seats, headrests, instrument panels, center consoles, the like, or any combination thereof. The ballistic composition and/or ballistic insert may be installed within compartments of the vehicle. The compartments may include an engine compartment, passenger compartment, luggage compartment, the like, or any combination thereof.

The ballistic composition and/or ballistic insert may be augmented with other properties. The ballistic composition and/or ballistic insert may be augmented with the properties of a crash insert, an NVH (i.e., noise, vibration, harshness) insert, a structural insert, or any combination thereof. For example, the ballistic composition may be formulated to dampen noise, vibration, and harshness and may be installed in portions of the vehicle where NVH inserts would have otherwise been installed. In this manner, the ballistic composition and/or ballistic insert may serve multiple functions, so the end-user does not have to sacrifice one function for another. Non-limiting examples of NVH inserts are taught in U.S. Pat. No. 7,597,382, incorporated herein by reference for all purposes.

The present disclosure provides for a ballistic composition. The ballistic composition may function to provide ballistic protection, structural reinforcement, adhesion, baffling, acoustical damping, or any combination thereof. The ballistic composition may be disposed within a cavity and/or upon a surface of a vehicle component. The ballistic composition may at least partially fill a cavity. The ballistic composition may foam to at least partially fill a cavity. The ballistic composition may adhere to a cavity wall, surface, or both. The ballistic composition may interface with a vehicle component, ballistic insert, or both. The ballistic composition may be disposed on a ballistic insert, between two or more ballistic inserts, between one or more ballistic inserts and one or more vehicle components, or any combination thereof. The ballistic insert may be located on one or more sides of the ballistic composition. The ballistic insert may at least partially surround the ballistic composition. The ballistic composition may be chemically and/or mechanically fastened to a cavity and/or surface of a vehicle component, ballistic insert, or any combination thereof. Mechanically fasten may refer to the use of fasteners, interlocking members, or both. The fasteners may include bolts, screws, rivets, push pins, the like, or any combination thereof. The interlocking members may include a protrusion of the ballistic composition and a recess in the element to which the ballistic composition is fastened to, or vice versa. For example, the ballistic composition may be molded to include a protrusion and then a ballistic insert may be overmolded onto the ballistic composition, the ballistic insert including a recess that accepts the protrusion. Chemically fasten may refer to the use of an adhesive, adhesive property inherent to the ballistic composition, or both. The adhesive may include epoxy, polyurethane, polyimide, cyanoacrylate, phenol, methacrylate, the like, or any combination thereof. The ballistic composition may be flowable in a first state and generally solid in a second state. The ballistic composition may be fully activated (e.g., cured) to transition from the first state to the second state. The ballistic composition may be reformable upon the application of heat (e.g., thermoplastic). The ballistic composition may foam upon activation. The ballistic composition may be partially activated (i.e., intermediate state). By partially activating the ballistic composition, the ballistic composition may be formable (i.e., malleable) and generally retain its formed shape. The ballistic composition may be applied to a vehicle and/or ballistic insert while in its flowable, malleable, or solid state. For example, the ballistic composition may be flowed into a vehicle cavity. As another example, the ballistic composition may be partially activated, formed, and applied to a ballistic insert. As yet another example, the ballistic composition may be fully activated and then applied to a ballistic insert. The ballistic composition and/or the ballistic insert may be installed by an OEM, aftermarket shop, or both. The ballistic composition may comprise one or more of: a curable material, cement, polymeric material, fiber component, particulate component, blowing agent, blowing agent accelerator, curing agent, curing agent accelerator, additive, or any combination thereof.

The ballistic composition, ballistic insert, or both may meet one or more industry standards and/or protection ratings. The ballistic composition, ballistic insert, or both may meet any one of the ratings provided by: Underwriter Lab (“UL”) 752 (Standard for Bullet-Resisting Equipment); Ballistic Resistance of Body Armor, National Institute of Justice (“NIJ”) Standard-0101.06; Stab Resistance of Personal Body Armor, NIJ Standard-0115.00; or any combination thereof, which are incorporated herein by reference for all purposes. As will be discussed further herein, the physical properties and/or composition of the ballistic composition, ballistic insert, or both may be selectively chosen in order to meet any one of the ratings provided by the standards listed above. In this manner, a consumer may choose the level of protection based upon the consumer's own judgment of potential threat level and the consumer need not pay for a level of protection they do not need. It may be appreciated that the ballistic composition of the present disclosure may be easily and quickly modified to meet any desired rating. For example, a consumer anticipating the need for protection against projectiles fired from rifles (e.g., 7.62 mm FMJ, steel jacketed bullets) may choose a ballistic composition, ballistic insert, or both rated Type III, according to NIJ Standard-0101.06. As referred to herein, “projectile” may include a bullet, arrow, piece of shrapnel, the like, or any combination thereof. The shrapnel may originate from an explosion, explosive device, or both.

The ballistic composition may comprise a curable material that cures and/or foams (or is otherwise activated) upon exposure to a stimulus. The curable material may function to suspend a fiber component, suspend a particulate component, absorb energy, fill cavities, provide structural reinforcement, provide adhesion, baffle, provide acoustical damping, or any combination thereof. The curable material may include any material that may be activated to expand, melt, flow, cure (e.g., thermoset), foam, develop adhesion, or any combination thereof. The curable material may be activated by a stimulus. The stimulus may include heat, pressure, chemical exposure, moisture exposure, UV light, the like, or any combination thereof. The curable material may activate at room temperature (i.e., 20-25° C.). The curable material may activate at temperatures typically used for E-coat ovens (i.e., between about 82° C. and 193° C.). The ballistic composition may include a two-part composition. The two-part composition may activate via chemical exposure when the two separate parts are mixed (e.g., mixing a first part including a polymerizable material and a second part including a suitable curing agent). The two-part composition may activate at room temperature. The curable material may be present in the ballistic composition in an amount of about 5% or more, 10% or more, 20% or more, 30% or more, or even 40% or more, by weight of the ballistic composition. The curable material may be present in the ballistic composition in an amount of about 80% or less, 70% or less, 60% or less, or even 50% or less, by weight of the ballistic composition. The curable material may include one or more cements, polymeric materials, or both.

The curable material may include one or more cements. The cement may include a binder and aggregate mixture. The binder may include fly ash, ground granulated blast-furnace slag, limestone, the like, or any combination thereof. The aggregate may include metal aggregate (e.g., recycled steel furnace slag), glass aggregate, mineral aggregate, or any combination thereof. The mineral aggregate may include pea gravel, crushed rock, sand, the like, or any combination thereof. The aggregate may be course grade, fine grade, all-in grade, or any combination thereof. The cement may include hydraulic cement, non-hydraulic cement, or both. An example of a suitable cement may include Portland cement, although other types of cement are contemplated. The cement may be present in the ballistic composition in an amount of about 5% or more, 10% or more, 20% or more, 30% or more, or even 40% or more, by weight of the ballistic composition. The cement may be present in the ballistic composition in an amount of about 80% or less, 70% or less, 60% or less, or even 50% or less, by weight of the ballistic composition.

The curable material may include one or more polymeric materials. The polymeric material may include one or more of a thermoset, thermoplastic, elastomer, plastomer, the like, or any combination thereof. The polymeric material may include one or more of a polycarbonate, polyketone, polyurethane, polyester, polysilane, polysiloxane, polysulfone, epoxy resin, phenolic resin, rubber, poly(p-phenylene oxide), poly(ethylene terephthalate), poly(ethylene-vinyl acetate), polyacrylate, polymethacrylate, polyolefin (e.g., polyethylene, polypropylene), polystyrene, poly(ethyleneimine), polyether (e.g., poly(ethylene oxide)), polyphosphazine, polyamide, polyimide, polyisobutylene, polyacrylonitrile, poly(vinyl chloride), poly(methyl methacrylate), poly(vinyl acetate), polyisocyanurate, poly(vinylidene chloride), polytetrafluoroethylene, polyisoprene, polyacrylamide, poly(acrylic acid), the like, or any combination thereof. The polyethylene may include ultra-high-molecular-weight polyethylene, high-density polyethylene, cross-linked polyethylene, medium-density polyethylene, linear low-density polyethylene, low-density polyethylene, very-low-density polyethylene, or any combination thereof. The rubber may include nitrile butadiene rubber, hydrogenated nitrile butadiene rubber, ethylene propylene diene monomer rubber, the like, or any combination thereof. The polymeric material may be halogenated. The ballistic composition may include a polymeric material in an amount of about 5% or more, 10% or more, 20% or more, 30% or more, or even 40% or more, by weight of the ballistic composition. The ballistic composition may include a polymeric material in an amount of about 85% or less, 80% or less, 70%, or less, 60% or less, or even 50% or less, by weight of the ballistic composition. The polymeric material may be present in an A-side of a two-component composition.

Epoxy resin may refer to any conventional dimeric, oligomeric, or polymeric epoxy resin containing at least one epoxy functional group. The epoxy resin may include one or more oxirane rings polymerizable by a ring opening reaction. The epoxy resin may be aliphatic, cycloaliphatic, aromatic, the like, or any combination thereof. The epoxy resin may be solid, liquid, or both. As referred to herein, solid epoxy resin may mean solid at about room temperature (i.e., 20-25° C.). Solid epoxy resin may be supplied as pellets, chunks, pieces, the like, or any combination thereof. The epoxy resin may include diglycidyl ethers of dihydric phenols, biphenyl epoxy resin, naphthalene-based epoxy resin, epoxy phenol novolac, epoxy cresol novolac, tris-hydroxyphenylmethane triglycidyl ether, tetraphenolethane glycidyl ether, the like, or any combination thereof. The dihydric phenols may include bisphenol A, bisphenol F, brominated bisphenol A, hydrogenated bisphenol A, bisphenol S, bisphenol AF, bisphenol K, the like, or any combination thereof. Examples of other suitable dihydric phenols are taught in U.S. Pat. No. 5,115,075, incorporated herein by reference for all purposes. The epoxy resin may be incorporated with one or more polymers, resulting in a polymer having at least one epoxide group. Polymers having at least one epoxide group have been described, along with illustrative synthesis conditions, in U.S. Pat. Nos. 3,317,471, 4,438,254, 4,647,648, and 6,011,111; U.S. Patent Application Publication No. 2007/0270515 (see e.g., paragraphs 15-25); and W.I.P.O. Publication No. 1998/014498 (see e.g., pages 3-8), which are incorporated herein by reference for all purposes. Suitable epoxy resins may include one or any combination of D.E.R.™ 331′, commercially available from Dow (a bisphenol-A-based liquid epoxy resin); Epalloy® 8250, commercially available from Huntsman Corporation (an epoxidized phenol novolac); ERISYS® GE-60, commercially available from Huntsman Corporation (an epoxidized sorbitol); Kane Ace MX-257, commercially available from Kaneka (a bisphenol-A-based liquid epoxy resin including a 37% concentration of 200 nm PBd core-shell polymers); Kane Ace MX-267, commercially available from Kaneka (a bisphenol-F-based liquid epoxy resin including a 37% concentration of 200 nm core-shell polymers); EPOKUKDO KSR 177, commercially available from Kaneka (an epoxy resin); Cardolite® NC-514, commercially available from Cardolite (a diglycidyl ether epoxy resin); D.E.R.™ 732, commercially available from Dow (a liquid epoxy resin obtained as a reaction product of epichlorohydrin and polypropylene glycol). The epoxy resin may increase adhesion properties of the curable material. The epoxy resin may include an ethylene copolymer or terpolymer that may possess an alpha-olefin. The copolymer or terpolymer may be composed of two or three different monomers. The ballistic composition may include an epoxy resin in an amount of about 5% or more, 10% or more, 20% or more, 30% or more, or even 40% or more, by weight of the ballistic composition. The ballistic composition may include a polymeric material in an amount of about 85% or less, 80% or less, 70%, or less, 60% or less, or even 50% or less, by weight of the ballistic composition. The epoxy resin may be present in an A-side of a two-component composition.

The elastomer may include an epoxy/elastomer adduct. An example of a suitable epoxy/elastomer adduct may include Epoxonic 328, commercially available from Epoxinic.

The curable material may comprise one or more phosphate esters. The phosphate esters may be selected from mono-esters, di-esters, or tri-esters as shown below:

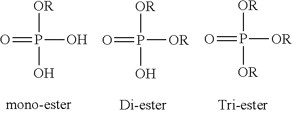

The one or more phosphate esters may be obtained from the reaction of epoxide groups with phosphoric acid as depicted below:

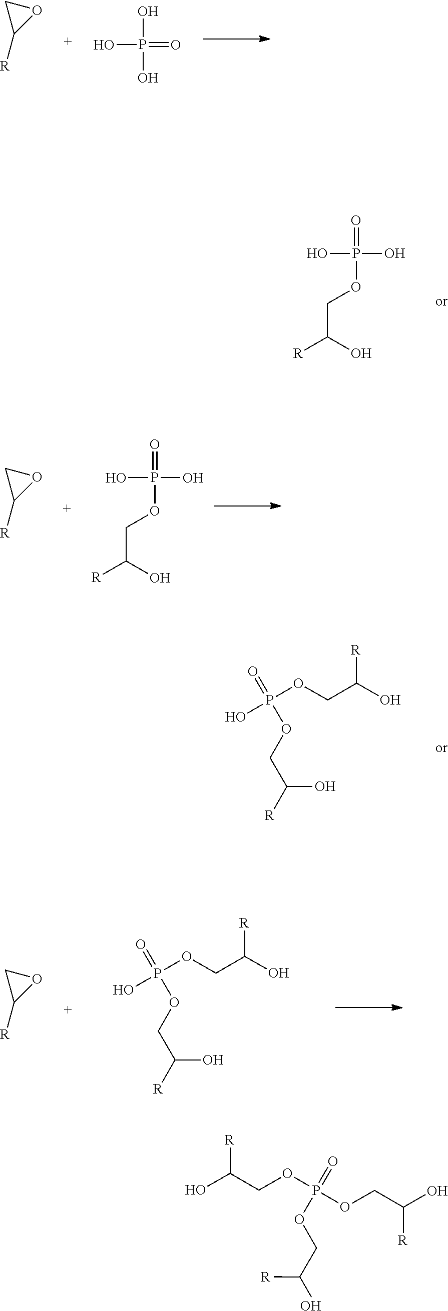

The phosphate ester may include a reaction product of phosphoric acid with the glycidyl ether of cashew nutshell liquid (CNSL) (e.g., Cardolite® LITE 2513HP); a reaction product of a stoichiometric amount of about 1:1 2-ethylhexyl glycidyl (e.g., ERISYS® GE-6) to phosphoric acid; a reaction product of a stoichiometric amount of 0.8:1 phosphoric acid with 2-ethylhexyl glycidyl ether (e.g., ERISYS® GE-6); or any combination thereof. However, there are numerous possibilities for the first, second, or third phosphate ester. Suitable examples of phosphate esters, precursors thereof, preparation methods, and formulations incorporating the same may be found in International Publication No. 2020-206346 A1, incorporated herein by reference for all purposes. The first phosphate ester may be present, in a B-side of a two-part composition, in an amount about 10% or more, 15% or more, 20% or more, 25% or more, 30% or more, or even 35% or more, by weight of the B-side. The phosphate ester may be present, in a B-side of a two-part composition, in an amount about 80% or less, 75% or less, 70% or less, 65% or less, or even 60% or less, by weight of the B-side. The B-side may include phosphoric acid. The phosphoric acid may be ortho-phosphoric acid, polyphosphoric acid, or both. The phosphoric acid may be polyphosphoric acid. The phosphoric acid may be free acid in the one or more phosphate esters, added independently from the one or more phosphate esters, or both. The addition of phosphoric acid to the B-side may result in increased expansion (e.g., foaming) of the resulting reaction product. The addition of phosphoric acid to the B-side may increase the reactivity of the two-part composition to help maintain desired levels of expansion, curing, or both when temperatures are below 23° C.

The ballistic composition may comprise one or more fiber components. The fiber component may function to structurally reinforce the ballistic composition, improve tensile strength, improve flexural strength, absorb energy from a projectile, impose resistance on a projectile, impose a tortuous path on a projectile, or any combination thereof. The fiber component may be homogenously or non-homogenously dispersed within the ballistic composition. The fiber component may comprise one or more types of fibers. The fiber component may comprise polymeric fiber, glass fiber (e.g., fiberglass), carbon fiber, the like, or any combination thereof. Polymeric fiber may include nylon, polyamide, polyester, polypropylene, polyethylene, polytetrafluoroethylene, aramid (e.g., Kevlar®), the like, or any combination thereof. Glass fiber may include alumino-borosilicate glass, alkali-lime glass, electrical/chemical resistance glass, borosilicate glass, alumino-silicate glass, the like, or any combination thereof. The fiber component may be present in the ballistic composition in an amount of about 1% or more, 5% or more, 10% or more, 20% or more, or even 30% or more, by weight of the ballistic composition. The fiber component may be present in the ballistic composition in an amount of about 60% or less, 50% or less, or even 40% or less, by weight of the ballistic composition. The fiber component may include chopped fiber. The chopped fiber may have an average length of about 0.1 cm or more, 0.3 cm or more, 0.6 cm or more, 0.8 cm or more, or even 1 cm or more. The chopped fiber may have an average length of about 4 cm or less, 3.5 cm or less, 3 cm or less, 2.5 cm or less, 2 cm or less, or even 1.5 cm or less.

As used herein, “tortuous path” may refer to a path of travel of the projectile having one or more bends, turns, twists, the like, or any combination thereof, which are not typical of a substantially parabolic path of a projectile. Whereas a projectile unimpeded by a physical barrier may travel a substantially parabolic path, a projectile contacting a physical barrier may be slowed, stopped, deflected, suspended, deformed, the like, or any combination thereof, depending upon both the physical characteristics of said barrier (e.g., hardness, thickness, elasticity, material, the like, or any combination thereof) and the position of a physical barrier in space (e.g., the angular relationship of a surface and/or tangent with the path of the projectile). As used herein, “deflect” may refer to the angular difference between the path of travel of the projectile before contacting a physical barrier and the path of travel of the projectile after contacting the physical barrier. Deflection may be characterized by an angular measurement.

The ballistic composition may include one or more core-shell polymers. The core-shell polymers may comprise a first polymeric material (i.e., core material) and a second polymeric material (i.e., shell material). The first polymeric material may be entirely encapsulated by the second polymeric material. The core-shell polymer may include a first polymeric material in the amount of about 30% or more, 50% or more, or even 70% or more by weight. The first polymeric material, the second polymeric material, or both may comprise one, two, three, or even more than three polymers that are combined together, reacted together (e.g., sequentially polymerized), or both, or may be part of separate or the same core-shell polymer systems. The core-shell polymers may be present in an amount of about 1% or more, 5% or more, or even 10% or more, by weight of the ballistic composition. The core-shell polymers may be present in an amount of about 25% or less, 20% or less, or even 15% or less, by weight of the ballistic composition.

The ballistic composition may include one or more particulate components. The particulate component may function to structurally reinforce the ballistic composition, improve tensile strength, improve flexural strength, absorb energy from a projectile, impose resistance on a projectile, impose a tortuous path on a projectile, or any combination thereof. The particulate component may be homogenously or non-homogenously dispersed within the ballistic composition. The particulate component may be chosen from polymer, ceramic, metal, or any combination thereof. The polymer may include polyethylene (e.g., high molecular weight or ultrahigh molecular weight polyethylene), polybenzoxazole, the like, or any combination thereof. The ceramic may include alumina, boron carbide, silicon carbide, titanium diboride, the like, or any combination thereof. The metal may include iron, steel, aluminum, titanium, zinc, brass, alloys thereof, the like, or any combination thereof. The particulate component may be in the form of moldings, castings, shavings, the like, or any combination thereof. The particulate component may have one or more flat sides, curved sides, jagged sides, or any combination thereof. The particulate components may be in the form of a three-dimensional shape. The three-dimensional shape may be polyhedral (e.g., tetrahedral), rod-like, tubular, the like, or any combination thereof. The three-dimensional shape may be solid, hollow, or both. The particulate component may be generally flat. A flat particulate component may have a shaped profile. The shaped profile may be triangular, quadrilateral, pentagonal, hexagonal, the like, or any combination thereof. The particulate components may be defined by a length, width, thickness, or any combination thereof. The length may be about 0.5 cm or more, 1 cm or more, 3 cm or more, 5 cm or more, or even 7 cm or more. The length may be about 15 cm or less, 13 cm or less, 11 cm or less, or even 9 cm or less. The width may be about 0.5 cm or more, 1 cm or more, 3 cm or more, 5 cm or more, or even 7 cm or more. The width may be about 15 cm or less, 13 cm or less, 11 cm or less, or even 9 cm or less. The thickness may be about 1 mm or more, 5 mm or more, 1 cm or more, or even 2 cm or more. The thickness may be about 5 cm or less, 4 cm or less, or even 3 cm or less. The particulate component may be present in the ballistic composition in an amount of about 5% or more, 10% or more, 20% or more, 30% or more, or even 40% or more, by weight of the ballistic composition. The particulate component may be present in the ballistic composition in an amount of about 70% or less, 60% or less, or even 50% or less, by weight of the ballistic composition.

The ballistic composition may include one or more blowing agents. The blowing agent may function to produce inert gasses that form an open cellular structure and/or closed cellular structure within the curable material. In this manner, it may be possible to modify the density of articles fabricated from the curable material as required for a particular application. The blowing agent may include a chemical blowing agent, physical blowing agent, or both. The chemical blowing agent may thermally decompose and evolve gas due to the heat of an exothermic reaction. The chemical blowing agent may include one or more nitrogen containing groups such as amides, amines, the like, or any combination thereof. The chemical blowing agent may include azodicarbonamide, dinitrosopentamethylenetetramine, 4,4i-oxy-bis-(benzenesulphonylhydrazide), trihydrazinotriazine, N,Ni-dimethyl-N,Ni-dinitrosoterephthalamide, or any combination thereof. Non-limiting examples of other suitable chemical blowing agents may include Cellcom® CF810, commercially available from Kumyang, and Celogen® 754A, commercially available from CelChem LLC. The curable material may include a physical blowing agent. The physical blowing agent may comprise a thermoplastic shell with a solvent core, the solvent producing gas due to heat. The physical blowing agent may include, but is not limited to, those sold under the designations Expancel®, commercially available from AkzoNobel. The curable material may be manufactured according to the MuCell® process available from Trexel. Amounts of blowing agents can vary widely within the ballistic composition depending upon the type of cellular structure desired, the desired amount of expansion of the ballistic composition, the desired rate of expansion, the like, or any combination thereof. The blowing agent may be present in the ballistic composition in an amount of about 0.001% or more, 0.01% or more, 0.1% or more, 1% or more, 2% or more, or even 2.5% or more, by weight of the ballistic composition. The blowing agent may be present in the ballistic composition in an amount of about 5% or less, 4.5% or less, 4% or less, 3.5% or less, or even 3% or less, by weight of the ballistic composition. The ballistic composition may foam upon activation. The ballistic composition may foam to a volume greater than the ballistic composition's volume in its green state. As referred to herein, “green state” may mean the original, unfoamed volume prior to subjecting the ballistic composition to a stimulus. The volume of the ballistic composition may be less after activation, relative to its green state, due to curing (e.g., cross-linking) for foamed or un-foamed versions of the ballistic composition. The blowing agent may be present in the ballistic composition in an amount that causes the ballistic composition to foam to a volume of about 5% or more, 10% or more, 50% or more, 100% or more, or even 200% or more, relative to the ballistic composition's green state volume. The blowing agent may be present in the ballistic composition in an amount the causes the ballistic composition to foam to a volume of about 800% or less, 700% or less, 600% or less, 500% or less, or even 400% or less, relative to the ballistic composition's green state volume.

The ballistic composition may include one or more blowing agent accelerators. The blowing agent accelerator may function to increase the rate and/or reduce the temperature at which the blowing agents form inert gasses. Examples of suitable blowing agent accelerators may include one or more of a metal salt, metal oxide (e.g., zinc oxide), modified thiazole, unmodified thiazole, urea, imidazole, the like, or any combination thereof. Amounts of blowing agent accelerators may vary widely within the ballistic composition depending upon the type of cellular structure desired, the desired amount of expansion of the ballistic composition, the desired rate of expansion, the like, or any combination thereof. The blowing agent accelerator may be present in the ballistic composition in an amount of about 0.001% or more, 0.01% or more, 0.1% or more, 1% or more, 2% or more, or even 2.5% or more, by weight of the ballistic composition. The blowing agent accelerator may be present in the ballistic composition in an amount of about 5% or less, 4.5% or less, 4% or less, 3.5% or less, or even 3% or less, by weight of the ballistic composition.

The ballistic composition may include one or more curing agents. The curing agent may function to cause chemical bonding in a chain-extending reaction, cross-linking reaction, or both. The curing agent may be chosen in accordance with the type of polymeric material, the temperature at which the polymeric material cures, the temperature at which the blowing agent activates (i.e., begins to generate gas and cause the ballistic composition to foam), or any combination thereof. In some applications, the curing agent may include atmospheric moisture (e.g., moisture-cured polyurethane). Curing agents for epoxy resin may include polyaddition type, catalyst type, and condensation type curing agents. The polyaddition type curing agents may include, but are not limited to, polyamine-based dicyandiamide, acid anhydride-based methyl nadic acid anhydride, the like, or any combination thereof. The catalyst type curing agents may include, but are not limited to, imidazole-based 2-methyllmidazole, 2-ethyl 4-methylimidazole, 2-heptadecyl imidazole, Lewis acid-based monoethylamine boron trifluoride, piperazine boron trifluoride, the like, or any combination thereof. Examples of other suitable curing agents may include those conventionally used to cure ethylene-based polymers, acrylate-based polymers, polyurethanes (e.g., phosphoric acid), or polyisocyanurates. The curing agent may be present in the ballistic composition in an amount of about 0.001% or more, 0.01% or more, 0.1% or more, 1% or more, or even 2% or more, by weight of the ballistic composition. The curing agent may be present in the ballistic composition in an amount of about 10% or less, 8% or less, 6% or less, 2% or less, or even 4% or less, by weight of the ballistic composition.

The ballistic composition may include one or more curing agent accelerators. The curing agent accelerator may function to accelerate the rate of cure. The curing agent accelerator may be present in the ballistic composition in an amount of about 0.001% or more, 0.01% or more, 0.1% or more, 1% or more, or even 2% or more, by weight of the ballistic composition. The curing agent accelerator may be present in the ballistic composition in an amount of about 10% or less, 8% or less, 6% or less, or even 4% or less, by weight of the ballistic composition.

The ballistic composition may include one or more additives. The additive may function to occupy space within the ballistic composition at a relatively low weight, impart strength to the ballistic composition, impact resistance to the ballistic composition, or any combination thereof. The additive, particularly clay, may assist the ballistic composition in leveling itself during flow. The additive may include silica, diatomaceous earth, ceramic microspheres, glass, clay, silicate, calcium carbonate, sodium carbonate, pigments, colorants, glass beads, glass bubbles, antioxidants, the like, or any combination thereof. The clay may include nanoclay, kaolinite, illite, chloritem, smecitite, sepiolite, the like, or any combination thereof. The clay may be calcined. The clay may include minor amounts of other ingredients such as carbonates, feldspars, micas, quartz, the like, or any combination thereof. The silicate may include wollastonite, talc, vermiculite, pyrophyllite, sauconite, saponite, nontronite, montmorillonite, the like, or any combination thereof. An example of a suitable wollastonite may include VANSIL® HR-2000, commercially available from Vanderbilt Worldwide Ltd. The additive may be generally non-reactive with the other components present in the ballistic composition. An example of a suitable silica may include CAB-O-SIL® TS-720 hydrophobic silica, commercially available from Cabot Corporation. Examples of suitable calcium carbonates may include Hubercarb® Q2 (ultra-fine grade) and Hubercarb® Q 200 (medium fine grade), commercially available from Huber Engineered Materials. An example of a suitable ceramic microsphere may include Zeeosphere N-1200, commercially available from Zeeospheres Ceramics, LLC. The additive may be present in the ballistic composition in an amount of about 5% or more, 10% or more, 20% or more, or even 30% or more, by weight of the ballistic composition. The additive may be present in the ballistic composition in an amount of about 60% or less, 50% or less, or even 40% or less, by weight of the ballistic composition. The additive may be present in an A-side and/or B-side of a two-component composition.

The ballistic composition may be used in conjunction with one or more ballistic inserts. The ballistic insert may function retain the ballistic composition, provide ballistic protection, structural reinforcement, adhesion, baffling, acoustical damping, or any combination thereof. A ballistic composition may be applied to the ballistic insert. The ballistic insert may be formed to fit a vehicle component, accept a ballistic composition, or both. The ballistic insert may be formed to contour a surface of a component of a vehicle. The ballistic insert may be formed by thermoforming, molding, pultrusion, overmolding, extrusion, co-extrusion, injection molding, co-injection molding, stamping, drawing, cutting, or any combination thereof. The ballistic insert, with or without a ballistic composition, may be installed in a vehicle. The ballistic insert may be mechanically and/or chemically fastened to one or more other ballistic inserts, vehicle components, or both. The ballistic insert may be welded, fastened, adhered, or otherwise connected to one or more other ballistic inserts, vehicle components, or both. The ballistic insert, ballistic composition, or both may be fastened together by overmolding, mechanical fastening, chemical fastening, flowing (e.g., pumping a ballistic composition in a flowable state into/onto the ballistic insert), or any combination thereof. Mechanically fasten may refer to the use of fasteners, interlocking members, or both. The fasteners may include bolts, screws, rivets, push pins, the like, or any combination thereof. The interlocking members may include a protrusion of the ballistic composition and a recess in the element to which the ballistic composition is fastened to, or vice versa. For example, the ballistic composition may be molded to include a protrusion and then a ballistic insert may be overmolded onto the ballistic composition, the ballistic insert including a recess that accepts the protrusion. Chemically fasten may refer to the use of an adhesive, adhesive property inherent to the ballistic composition, or both. The adhesive may include epoxy, polyurethane, polyimide, cyanoacrylate, phenol, methacrylate, the like, or any combination thereof. The ballistic insert may be located on one or more sides of the ballistic composition. The ballistic inserts may form a sandwich arrangement with a ballistic composition located in between two or more ballistic inserts. The ballistic inserts may at least partially surround a ballistic composition. The ballistic insert, or at least a portion thereof, may act as a baffle within a cavity. It may be advantageous for the ballistic insert to act as a baffle within cavities so flowable ballistic composition does not flow out of the cavity or disperse throughout the cavity. The combined ballistic insert and ballistic composition may be referred to herein as a ballistic assembly.

The ballistic insert may comprise metal, polymer, ceramic, or any combination thereof. The metal may include, but is not limited to iron, steel, aluminum, titanium, zinc, brass, alloys thereof, or any combination thereof. The polymer may include one or more of a thermoplastic, thermoset, or both. The polymer may include polyamide, polyurethane, thermoplastic epoxy resin, thermoplastic elastomeric rubber, thermoplastic vulcanite, thermoplastic elastomers, the like, or any combination thereof. The ceramic may include alumina, boron carbide, silicon carbide, titanium diboride, the like, or any combination thereof. The polymer may be filled with a fiber component. The fiber component may be homogenously or non-homogenously dispersed within the ballistic insert. The fiber component may comprise one or more types of fibers. The fiber component may comprise polymeric fiber, glass fiber (e.g., fiberglass), carbon fiber, the like, or any combination thereof. Polymeric fibers may include nylon, polyamide, polyester, polypropylene, polyethylene, polytetrafluoroethylene, aramid (e.g., Kevlar®), the like, or any combination thereof. Glass fibers may include alumino-borosilicate glass, alkali-lime glass, electrical/chemical resistance glass, borosilicate glass, alumino-silicate glass, the like, or any combination thereof. The fiber component may be present in the ballistic insert in an amount of about 1% or more, 5% or more, 10% or more, 20% or more, or even 30% or more, by weight of the ballistic insert. The fiber component may be present in the ballistic insert in an amount of about 60% or less, 50% or less, or even 40% or less, by weight of the ballistic insert. The fiber component may include chopped fiber. The chopped fiber may have an average length of about 0.1 cm or more, 0.3 cm or more, 0.6 cm or more, 0.8 cm or more, or even 1 cm or more. The chopped fiber may have an average length of about 4 cm or less, 3.5 cm or less, 3 cm or less, 2.5 cm or less, 2 cm or less, or even 1.5 cm or less.

The present disclosure provides for a method for fabricating a ballistic assembly. The method may comprise one or more of the following steps. Some of the steps may be duplicated, removed, rearranged relative to other steps, combined into one or more steps, separated into two or more steps, or any combination thereof. The method may include providing a ballistic composition, applying the ballistic composition to a ballistic insert, and curing the ballistic composition. The ballistic composition may comprise a curable material, fiber component, particulate component, or any combination thereof. The particulate component may be chosen from polymer, ceramic, metal, or any combination thereof. The fiber component, particulate component, or both may impose a tortuous path on a projectile.

The ballistic composition may be provided in a flowable state, partially activated state, or activated state. The curable material, and the particulate component and/or fiber component, may be provided pre-mixed or as separate components to be mixed immediately prior to application to a ballistic insert. The ballistic composition may be applied to the ballistic insert by pumping and/or flowing, overmolding, co-extruding, co-injection molding, mechanical fastening, chemical fastening, or any combination thereof. Mechanically fasten may refer to the use of fasteners, interlocking members, or both. The fasteners may include bolts, screws, rivets, push pins, the like, or any combination thereof. The interlocking members may include a protrusion of the ballistic composition and a recess on the element to which the ballistic composition is fastened to, or vice versa. For example, the ballistic composition may be molded to include a protrusion and then a ballistic insert may be overmolded onto the ballistic composition, the ballistic insert including a recess that accepts the protrusion. Chemically fasten may refer to the use of an adhesive, adhesive property inherent to the ballistic composition, or both. The adhesive may include epoxy, polyurethane, polyimide, cyanoacrylate, phenol, methacrylate, the like, or any combination thereof.

The ballistic composition may be applied to the ballistic insert by pumping and/or flowing the ballistic composition into and/or onto the ballistic insert, after the ballistic insert has been installed in a vehicle or prior to installing the ballistic insert in a vehicle. The ballistic composition may be overmolded, co-extruded, or co-injection molded with the ballistic insert. The ballistic composition may be applied to one or more ballistic inserts to form a ballistic assembly. The ballistic composition, ballistic insert, ballistic assembly, or any combination thereof may be installed in a vehicle prior to or after the vehicle undergoes an E-coat bake. For example, at a first point in an assembly line, the ballistic insert may be installed; at a second point in the assembly line, the ballistic composition, which is flowable, may be pumped into and/or onto the ballistic insert; and at a third point in the assembly line, the ballistic composition may be activated in an E-coat bake oven.

The ballistic composition may be partially activated before application to a ballistic insert. The partially activated ballistic composition may be pre-formed. The ballistic insert may be pre-formed. Pre-forming may be carried out by thermoforming. The ballistic composition, ballistic insert, or both may be formed to contour to one or more surfaces and/or cavities of a vehicle.

The ballistic composition may be activated before application to a ballistic insert. The activated ballistic composition may be activated in a mold to impart a shape to the ballistic composition. The activated ballistic composition may be shaped complementary to a shape of a ballistic insert.

The ballistic insert may be installed in a vehicle prior to application of the ballistic composition to the ballistic insert. The ballistic composition may be activated after being installed in a vehicle. The ballistic insert may be installed in a vehicle by the OEM during initial assembly of the vehicle and the ballistic composition may be applied to the ballistic insert a time after the initial assembly of the vehicle (e.g., after the consumer buys the vehicle) by an aftermarket shop. In this manner, the option to include ballistic protection in a vehicle may be enabled by the inclusion of the ballistic insert in the vehicle but the actual implementation of the ballistic protection (i.e., applying the ballistic composition to the ballistic insert) may be performed a time after the initial assembly of the vehicle.

The ballistic composition may be provided as one or more layers. One or more layers may have the same or a different composition as one or more other layers. For example, one layer may comprise curable material and a fiber component and a second layer may comprise curable material and a particulate component. One or more layers may be laminated with one or more other layers. One or more layers may be laminated together. One or more layers may be laminated onto one or more ballistic inserts.

The ballistic composition may be activated in an E-coat oven. The ballistic composition may activate at a temperature of about 82° C. or more 90° C. or more, 100° C. or more, 110° C. or more, 120° C. or more, or even 130° C. or more. The ballistic composition may activate at a temperature of about 193° C. or less, 180° C. or less, 170° C. or less, 160° C. or less, 150° C. or less, or even 140° C. or less. The ballistic composition may activate at a temperature of between about 20° C. and 25° C.

Tables 1 through 3 set forth exemplary formulations according to the present disclosure. The exemplary formulations comprise two-part compositions that are mixed and cured. Phosphate ester 1 provides for more flexibility of the ballistic composition. Phosphate ester 2 provides for more rigidity of the ballistic composition.

TABLE 1

| A Side | |
|---|---|
| D.E.R ™ 331 ™ | 10.00 |
| Epalloy ® 8250 | 42.00 |
| ERISYS ® GE-60 | 15.00 |
| Kane Ace MX-257 | 10.00 |
| Portland Cement | 23.00 |
| Total | 100.00 |
| B Side | |
| Phosphate ester 2 | 64.29 |
| Zeeosphere N-1200 | 28.57 |
| H3PO4 85% | 7.14 |
| Total | 100.00 |

TABLE 2

| A Side | |
|---|---|
| D.E.R ™ 331 ™ | 13.93 |
| Epalloy ® 8250 | 26.00 |
| ERISYS ® GE-60 | 13.00 |
| Kane Ace MX-257 | 18.57 |
| EPOKUKDO KSR 177 | 4.64 |
| Epoxonic 328 | 2.79 |
| Hubercarb ® Q2 | 0.28 |
| Hubercarb ® Q 200 | 1.02 |
| CAB-O-SIL ® TS 720 | 1.21 |
| Vansil ® HR2000 | 18.57 |
| Total | 100.00 |
| B Side | |
| Phosphate ester 1 | 15.81 |
| Phosphate ester 2 | 55.34 |
| Vansil HR2000 | 18.97 |
| CAB-O-SIL ® TS 720 | 3.56 |
| H3PO4 85% | 6.32 |
| Total | 100.00 |

TABLE 3

| A Side | |
|---|---|
| Epalloy ® 8250 | 44.99 |
| Cardolite ® NC-514 | 4.69 |
| Kane Ace MX-267 | 14.06 |
| EPOKUKDO KSR 177 | 9.37 |
| D.E.R ™ 331 ™ | 14.06 |
| Hubercarb ® Q2 | 0.84 |
| Hubercarb ® Q 200 | 1.69 |
| CAB-O-SIL ® TS 720 | 0.94 |
| Vansil HR2000 | 9.37 |
| Total | 100.00 |
| B Side | |
| Phosphate ester 1 | 22.12 |
| Phosphate ester 2 | 57.52 |
| Vansil ® HR2000 | 8.85 |
| CAB-O-SIL ® TS 720 | 2.65 |
| Epoxonic 328 | 1.77 |
| H3PO4 85% | 7.08 |
| Total | 100.00 |

A ballistic test was performed on the formulation of TABLE 1, filling an interior cavity of an A-pillar of a vehicle. A control sample comprised an A-pillar of a vehicle without any ballistic composition therein. The A-pillars were fabricated from die stamped cold rolled 20 gauge steel. A 44-magnum lead point round was fired from a 10.8 cm barrel at a distance of 25 yards, at the A-pillar with the formulation of TABLE 1 and the control A-pillar. The A-pillar with the formulation of TABLE 1 resulted in a dent in the structure, however no buckling, cracking, perforation, or otherwise was observed. The control A-pillar resulted in buckling and a crack through the material.

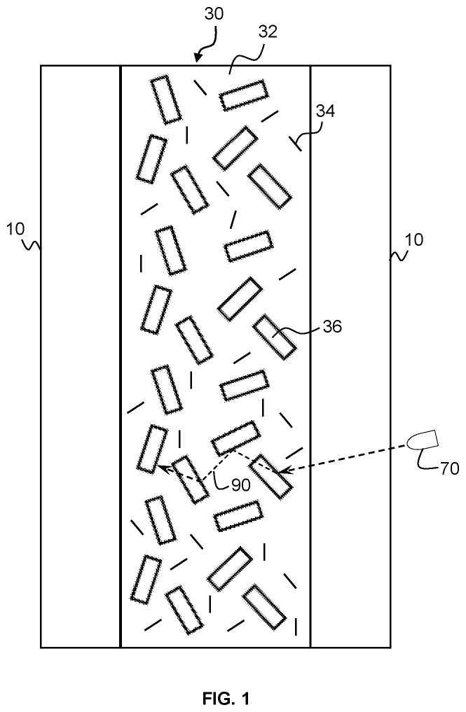

FIG. 1 illustrates two ballistic inserts 10 and a ballistic composition 30 disposed therebetween. The ballistic inserts 10 sandwich the ballistic composition 30. The ballistic composition 30 includes a curable material 32, particulate component 36, and fiber component 34. The particulate component 36 and fiber component 34 are homogeneously dispersed throughout the curable material 32. A projectile 70 is depicted on a flight path entering one of the ballistic inserts 10 and the ballistic composition 30. The interaction between the projectile 70 and the ballistic insert 10 results in the absorption of at least some of the kinetic energy of the projectile 70. Any remaining kinetic energy of the projectile 70 may be absorbed by the curable material 32, particulate component 36, and fiber component 34. In response to the projectile 70 contacting the particulate component 36, the projectile 70 proceeds along a tortuous path 90 through the ballistic composition 30. The projectile 70 is angularly deflected off of particulate components 36 in a direction related to the orientation of the particulate components 36 within the curable material 32, with respect to the path of the projectile 70.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

### REFERENCE NUMERALS

10—Ballistic insert; 30—Ballistic composition; 32—Curable material; 34—Fiber component; 36—Particulate component; 70—Projectile; 90—Tortuous path.

What is claimed is:

1: A ballistic composition comprising:
a curable material, and
a particulate component adapted to impose a tortuous path on a projectile;
wherein the particulate component includes polymer, ceramic, metal, or any combination thereof.

2: The ballistic composition according to claim 1, wherein the curable material includes a polymeric material.

3: The ballistic composition according to claim 1, wherein the curable material includes a cement.

4: The ballistic composition according to claim 1, wherein the curable material is present in the ballistic composition in an amount of about 5% to 80%, by weight of the ballistic composition; and wherein the particulate component is present in the ballistic composition in an amount of about 5% to 70%, by weight of the ballistic composition.

5: The ballistic composition according to claim 4, wherein the ballistic composition includes a fiber component, adapted to impose a tortuous path on a projectile; wherein the fiber component includes polymeric fiber, glass fiber, carbon fiber, or any combination thereof; and wherein the fiber component is present in the ballistic composition in an amount of about 1% to 60%, by weight of the ballistic composition.

6-7. (canceled)

8: The ballistic composition according to claim 5, wherein the ballistic composition comprises a blowing agent; wherein the blowing agent is present in the ballistic composition in an amount of about 0.001% to 5%, by weight of the ballistic composition; and wherein the ballistic composition foams, upon exposure to a stimulus, to a volume of about 5% to 800%, relative to a green state volume of the ballistic composition.

9-10. (canceled)

11: The ballistic composition according to claim 1, wherein the curable material activates at a temperature of between about 82° C. and 193° C. or between about 20° C. and 25° C.

12-15. (canceled)

16: The ballistic composition according to claim 5, wherein the fiber component, the particulate component, or both are homogenously dispersed throughout the ballistic composition.

17: The ballistic composition according to claim 1, wherein in an activated state, the ballistic composition meets UL 752, NIJ Standard-0101.06, NIJ Standard-0115.00, or any combination thereof.

18: A ballistic assembly comprising:
a ballistic composition including:
a curable material, and
a particulate component adapted to impose a tortuous path on a projectile; and
one or more ballistic inserts;
wherein the particulate component includes polymer, ceramic, metal, or any combination thereof.

19: The ballistic assembly according to claim 18, wherein the curable material includes a polymeric material.

20: The ballistic assembly according to claim 18, wherein the curable material includes a cement.

21: The ballistic assembly according to claim 18, wherein the curable material is present in the ballistic composition in an amount of about 5% to 80%, by weight of the ballistic composition; and wherein the particulate component is present in the ballistic composition in an amount of about 5% to 70%, by weight of the ballistic composition.

22: The ballistic assembly according to claim 21, wherein the ballistic composition includes a fiber component, adapted to impose a tortuous path on a projectile; wherein the fiber component includes polymeric fiber, glass fiber, carbon fiber, or any combination thereof; and wherein the fiber component is present in the ballistic composition in an amount of about 1% to 60%, by weight of the ballistic composition.

23-24. (canceled)

25: The ballistic assembly according to any claim 18, wherein the ballistic composition comprises a blowing agent; wherein the blowing agent is present in the ballistic composition in an amount of about 0.001% to 5%, by weight of the ballistic composition; and wherein the curable material foams, upon exposure to a stimulus, to a volume of about 5% to 800%, relative to a green state volume of the ballistic composition.

26-27. (canceled)

28: The ballistic assembly according to any claim 18, wherein the curable material activates at a temperature of between about 82° C. and 193° C. or between about 20° C. and 25° C.

29-34. (canceled)

35. A method for fabricating a ballistic assembly comprising:
(a) applying a ballistic composition to a ballistic insert and
(b) curing the ballistic composition;
wherein the ballistic composition comprises a curable material, a fiber component, a particulate component, or any combination thereof;
wherein the particulate component includes polymer, ceramic, metal, or any combination thereof; and
wherein the particulate component is adapted to impose a tortuous path on a projectile.

36: The method according to claim 35, wherein the ballistic composition is partially activated and/or pre-formed prior to being applied to the ballistic insert; and wherein the ballistic composition is applied to the ballistic insert by pumping and/or flowing, overmolding, co-extruding, co-injection molding, mechanical fastening, chemical fastening, or any combination thereof.

37-38. (canceled)

39: The method according to claim 36, wherein the method includes, prior to applying the ballistic composition to the ballistic insert, installing the ballistic insert within a cavity a vehicle.

40-41. (canceled)

42: The method according to claim 39, wherein the ballistic composition activates at a temperature range of between about 82° C. and about 193° C. or between about 20° C. and about 25° C.; and wherein the ballistic composition is activated in an E-coat oven.

43-44. (canceled)
